(19) United States
(12) Patent Application Publication
(10) Pub. No.: US 2026/0322821 A1
(43) Pub. Date: Oct. 15, 2026

(54) SYSTEMS AND METHODS FOR CONTROLLING EXECUTION OF PROVISIONING REQUESTS FOR CLOUD-BASED RESOURCES THAT ARE DYNAMICALLY ALLOCATED

(71) Applicant: Capital One Services, LLC, McLean, VA (US)

(72) Inventors: Stephen TIILIKAINEN, Centreville, VA (US); Parth PATEL, Frederick, MD (US)

(73) Assignee: Capital One Services, LLC, McLean, VA (US)

(21) Appl. No.: 19/177,483

(22) Filed: Apr. 11, 2025

(51) Int. Cl. H04L 9/40

(52) U.S. Cl. CPC H04L 63/102; H04L 63/108

(57) ABSTRACT

Systems and methods for controlling execution of provisioning requests for cloud-based resources that are dynamically allocated are disclosed. For example, a system can be configured to control execution of provisioning requests by obtaining a provisioning request, determining a request profile based on the provisioning request, and comparing the request profile to a network resource profile to determine an execution probability. This execution probability can then be compared to an execution threshold to allow the system to determine if a second system can successfully execute the provisioning request with a degree of certainty. If the probability satisfies the threshold, the system controls the first system to execute the request.

### BACKGROUND

The generation of requests for access to remote computing resources typically involves creating systems where users can submit their requirements for computing power, storage, or other resources. This can include specifying the type of resources needed, the duration of access, and any specific configurations. The requests can then be processed by a central system that allocates resources based on availability and priority, using various platforms and platform configurations that manage the distribution and monitoring of such resources.

However, there are several technical pitfalls associated with these techniques. One major issue is the potential for inefficient use of computing resources, leading to wasted processor and memory resources. Additionally, network communications can be strained if the system is not optimized for handling multiple requests simultaneously. This can result in delays and reduced performance for users. Effectively managing and optimizing the allocation of resources is crucial to avoid these pitfalls and ensure efficient operation.

### SUMMARY

Building on the above-noted challenges, when requesting resources from a third party that does not explicitly indicate how they provision and/or allocate resources across multiple requests, there can be significant uncertainty, leading to unpredictable performance and availability of the requested resources. And as a result, systems that are relying on the provisioning of these resources can experience delays, interruptions, or even unexpected deprovisioning if the availability of such resources from the third party are incorrectly estimated. Additionally, without clear information on how resources are distributed, it can be challenging to optimize the use of computing resources, potentially leading to wasted processor and memory resources. And in instances where the output that would otherwise be generated as a result of the provisioning or allocation of such resources are delayed, for example, in the context of model creation configured to identify malicious network activity, downstream systems configured to operate based on the availability of such outputs can be subject to prolonged periods of susceptibility to attacks involving systems controlled by malicious third parties. Network communications can also be affected, as the lack of clarity in resource allocation can result in inefficient handling of multiple requests, resulting in increased network traffic to establish when resources become available.

In some embodiments, systems and methods relate to novel uses and/or improvements when controlling execution of provisioning requests for cloud-based resources (e.g., instances, discrete computing devices such as central processing units, graphics processing units, etc.) virtual machines, storage devices, networking components, etc.) that are dynamically allocated. In an example, implementing the techniques described herein allows systems to be configured to more accurately estimate the probability that a given provisioning request will be executed successfully (e.g., without being paused or deprovisioned), which can reduce wasted computing resource consumption by minimizing overprovisioning or the execution of provisioning requests known to have a less-than-acceptable probability of being successfully executed. In some examples, accurate probability estimation can reduce the chances that provisioning requests lead to underutilized system resources and unnecessary energy expenditure. In an additional example, predicting the likelihood that a given provisioning request will be successfully executed allows provisioning requests to be selectively executed, again reducing the wasteful allocation of computing and/or network resources (e.g., networked computing resources that include processing/compute/etc., that are accessible over a network) to provisioning requests that will be unsuccessful. In a further example related to machine learning model deployment for detecting malicious network activity, accurate probability estimation can allow the timely provisioning of resources needed for training and deploying models, ensuring that computational tasks are initiated promptly without delays caused by resource mismanagement.

In some aspects, systems, and methods for controlling execution of provisioning requests for cloud-based resources that are dynamically allocated are described. For example, a system can have one or more processors that are configured to obtain a provisioning request from a first system for network resources at a second system. The provisioning request can indicate a set of operations to execute using the second system. The system can then determine a first request profile based on the provisioning request, which includes a first set of network resources and a first location. The first request profile can be compared to a network resource profile of the second system to determine an execution probability, which indicates the likelihood that the set of operations will be executed by the second system within a predetermined period. If the execution probability meets a certain threshold, the first system is allowed to execute the provisioning request based on this probability.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents, unless the context clearly dictates otherwise. In addition, as used in the specification and the claims, the term “or” means “and/or,” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows a diagram of an environment for controlling execution of provisioning requests for cloud-based resources that are dynamically allocated, in accordance with one or more embodiments.

FIG. 2 shows a flow diagram of a process for controlling execution of provisioning requests for cloud-based resources that are dynamically allocated, in accordance with one or more embodiments.

FIG. 3 shows components for a system used for controlling execution of provisioning requests for cloud-based resources that are dynamically allocated, in accordance with one or more embodiments.

FIG. 4 shows a flowchart of the steps involved in a process for controlling execution of provisioning requests for cloud-based resources that are dynamically allocated, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form to avoid unnecessarily obscuring the embodiments of the invention.

Some of the systems and methods described herein can be configured to control execution of provisioning requests for cloud-based resources that are dynamically allocated. In examples, systems described herein can have one or more processors that are configured to execute one or more operations. These operations can include obtaining a provisioning request from a first system (e.g., a client device) for network resources (e.g., a computing resource that are accessible over a network) at a second system (e.g., a resource management system). The provisioning request can indicate a set of operations to execute using the resources of the resource management system. In some examples, the system can determine a first request profile based on the provisioning request, including a first set of network resources and a first location. The system can then compare the first request profile to a network resource profile of the resource management system. This comparison can allow the system to determine an execution probability, indicating a probability that the set of operations will be successfully executed by the resource management system within a predetermined period of time. The system can compare the execution probability to an execution threshold to determine whether the execution probability indicates that the resource management system is configured to successfully execute the provisioning request. The system can then control the first system to execute the provisioning request based on the execution probability satisfying the execution threshold.

By controlling execution of provisioning requests as described, systems can be configured to more accurately estimate the probability of successful provisioning request execution, reducing wasted computing resource consumption by minimizing overprovisioning or execution of low-probability provisioning requests. In some examples, probabilistic provisioning reduces underutilized system resources and unnecessary energy expenditure, while enabling selective execution, based on the probability that a given provisioning request will be successfully executed. And in examples where resources are being provisioned for the training of machine learning models to detect malicious network activity, accurate probability estimation allows timely resource provisioning for training and deployment, allowing for computational tasks to be initiated promptly without delays from resource mismanagement.

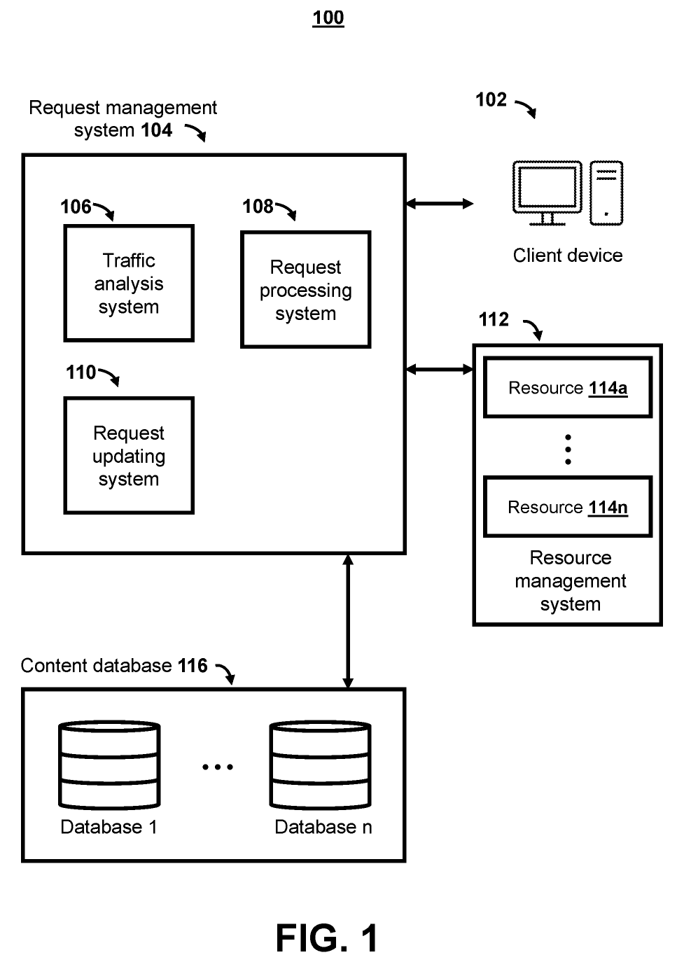

FIG. 1 shows a diagram of an environment (referred to as environment 100) that can be configured to, among other things, control execution of provisioning requests for cloud-based resources that are dynamically allocated, in accordance with one or more embodiments. For example, the environment 100 can include a client device 102, a request management system 104 having one or more components as described herein, a resource management system 112, and a content database 116. The client device 102, the request management system 104 (e.g., one or more components of the request management system 104), the resource management system 112, and/or the content database 116 can be configured to interconnect using one or more wired and/or wireless connections. As will be understood, the environment 100, as illustrated, includes a client device 102, a request management system 104, a resource management system 112, and a content database 116, but similar environments can include more devices that are the same as, or similar to, those described.

In some embodiments, the client device 102 can include a computing device that is configured to be in communication with the request management system 104 using one or more communication connections as described herein. For example, the client device 102 can include a desktop computer, a laptop computer, a smartphone, a tablet, and/or the like. In some embodiments, the client device 102 can be involved in (e.g., can direct) the execution of one or more requests to provision resources maintained by the resource management system 112. As described herein, the client device 102 (e.g., one or more components of the request management system 104 ) can establish one or more secured or unsecured communication connections with the request management system 104.

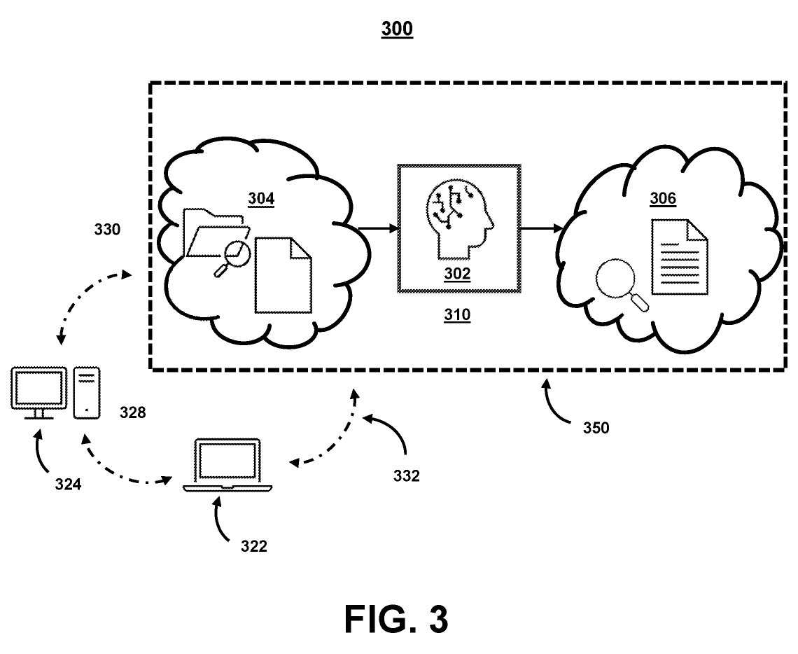

In some embodiments, the request management system 104 can include a computing device that is configured to be in communication with the client device 102, the resource management system 112, and/or the content database 116 using one or more secured or unsecured communication paths (also referred to as communication connections) as described herein. For example, the request management system 104 can include a desktop computer, a laptop computer, a smartphone, a tablet, and/or the like. In some embodiments, the request management system 104 can include (e.g., implement) a traffic analysis system 106, a request processing system 108, and/or a request updating system 110. While certain components are illustrated by FIG. 1, the request management system 104 can include and/or exclude one or more of the illustrated components. The request management system 104 can also include one or more components that are the same as, or similar to, the user terminal 324 of FIG. 3. In some embodiments, the request management system 104 can be implemented by one or more other devices of FIG. 1, such as the client device 102 and/or the resource management system 112. The request management system 104 can be configured to process provisioning requests and, in certain instances, update the provisioning request before causing execution of the provisioning requests. Additionally, or alternatively, the request management system 104 can be configured to analyze aspects of one or more provisioning requests over time to generate profiles and determine execution probabilities as described herein.

In some embodiments, the resource management system 112 can include a computing device that is configured to be in communication with the request management system 104 using one or more communication connections as described herein. For example, the resource management system 112 can include a cloud-based server system, a server, a desktop computer, a laptop computer, a smartphone, a tablet, and/or the like. In some embodiments, the resource management system 112 can include (e.g., implement) computing resources (referred to individually as a resource 114 and collectively as resources 114, as is contextually appropriate).

In some embodiments, the resources 114 can include computing resources, such as one or more hardware computer components, like central processing units (CPUs), graphics processing units (GPUs), memory, and disk storage. In examples, the resources 114 can be configured based on provisioning requests to implement one or more predetermined resource configurations. In an example where a resource 114 is configured for machine learning (ML) model training, the resource 114 can be configured to include multiple GPUs to accelerate deep learning tasks, a CPU for data preprocessing, memory to handle large datasets, and high-performance storage to ensure rapid data access. In another example, the resource 114 can be provisioned to implement a web server by configuring the resource 114 with sufficient CPUs for handling concurrent requests, memory, and appropriate disk storage to host web content. In some embodiments, the resource 114 can be dynamically configured (e.g., adjusted) based on specific requirements, such as prioritizing GPUs configurable to execute inference-based tasks, etc. In these examples, the resource management system 112 can implement on-demand resource provisioning to dynamically allocate and configure components involved in implementing the resources 114 as is desirable, allowing for efficient scaling and optimization based on changing workload demands.

In some embodiments, the content database 116 can include a computing device that is configured to be in communication with the request management system 104 using one or more communication connections as described herein. For example, the content database 116 can include a desktop computer, a laptop computer, a smartphone, a tablet, and/or the like. In some embodiments, the content database 116 can include (e.g., implement) a one or more datasets that include data that is obtained and/or generated by the request management system 104 (e.g., by the traffic analysis system 106). For example, the content database 116 can obtain data obtained from the client device 102, indicating one or more provisioning requests generated over a period of time, data obtained from the resource management system 112, indicating the availability, or the probability of availability, of one or more resources 114 at particular points or periods of time during a period of time.

While certain components are illustrated by FIG. 1, the environment 100, or the various devices thereof, can include and/or exclude one or more of the illustrated components. The environment 100 can also include one or more components that are the same as, or similar to, the devices of FIG. 3. In some embodiments, the devices of the environment 100 can be configured to establish direct or indirect communication connections between one another. For example, one or more networks can establish communication paths between one or more of the devices of the environment 100 to allow for the communication of messages (e.g., network packets, etc.) therebetween. In this example, the communication paths can be the same as, or similar to, the communication paths 328, 330, and 332 of FIG. 3. The network(s) can include mobile phone networks, mobile voice or data networks, cable networks, public switched telephone networks, the Internet, or other types of communications networks or combinations of communications networks as described herein.

It will be understood that the number and arrangement of devices in the environment 100 are provided as an example, and that there can be differently arranged environments than those shown in FIG. 1. In some embodiments, at least some of the device(s) and/or system(s) of FIG. 1 can be implemented by a single device or multiple devices within a distributed system. For example, the request management system 104 can be implemented by a single device or as multiple devices that, either alone or in coordination, perform one or more of the operations as described herein.

With continued reference to FIG. 1, one or more of the components of the environment 100 can be configured to control execution of provisioning requests for cloud-based resources that are dynamically allocated. For example, the request management system 104 can be configured to establish a communication connection with the client device 102. In examples, the client device 102 can be operated by users, such as network administrators, etc., that are involved in configuring and executing one or more provisioning requests. In various examples, the request management system 104 can be implemented by the client device 102 and/or by the resource management system 112. In other examples, the request management system 104 can be implemented by the resource management system 112 and accessible, via the client device 102, establishing one or more communication connections with these devices.

In some embodiments, a traffic analysis system 106 can obtain a plurality of availability probabilities corresponding to a plurality of availability indicators, indicating the probability that the resources 114 will be available for a given provisioning request. For example, the traffic analysis system 106 can obtain a plurality of availability probabilities corresponding to a plurality of availability indicators from the resource management system 112. These availability probabilities can correspond to respective provisioning requests provided by the client device 102 or other client devices (not explicitly illustrated). In this example, each availability probability can represent a likelihood that resources 114 will be available at one or more points in time to satisfy a provisioning request. In some environments, the traffic analysis system 106 can obtain data from the resource management system 112, indicating whether one or more provisioning requests were satisfied at one or more points or periods of time, such as over a day, a week, year, etc. In some embodiments, the traffic analysis system 106 can calculate these probabilities by obtaining data indicating the network traffic patterns, historical resource utilization data, etc., associated with operation of the resource management system 112 to estimate future resource availability. In this example, the availability probabilities can incorporate factors, such as peak usage times, network congestion trends, and anticipated demand fluctuations to provide a probabilistic measure of resource accessibility. In these ways, the traffic analysis system 106 can generate probability indicators representing the likelihood that resources 114 will be available over a given period of time, allowing the request processing system 108 and/or the request updating system 110 to execute operations as described. In these ways, the traffic analysis system 106 can generate probability indicators representing the likelihood that various resources 114 will be available over a given period of time, allowing the request processing system 108 and/or the request updating system 110 to execute operations as described. And in some examples, the traffic analysis system 106 can store these probability indicators and related availability information as network resource profiles in databases maintained by the content database 116, allowing the request processing system 108 and the request updating system 110 have access to accurate and up-to-date resource availability data when executing operations, respectively.

In some examples, the traffic analysis system 106 can update the plurality of availability indicators based on the obtained availability probabilities to ensure that the indicators accurately reflect current and projected resource conditions. In these examples, the traffic analysis system 106 can generate a network resource profile that consolidates the updated availability indicators and provides probabilities that various resources 114 will be available over a given period of time. This network resource profile can serve as a comprehensive representation of resource availability, allowing for informed decision-making for provisioning requests.

In some embodiments, the request management system 104 can be configured to obtain a provisioning request from the client device 102. For example, the request management system 104 can establish a communication connection that allows the client device 102 to submit provisioning requests to allocate resources 114 at the resource management system 112 when executing a particular task. In this example, the communication connection can be implemented through a user interface, such as a web portal or mobile application, displayable via a display device at the client device 102. This user interface can allow users to input configuration parameters, such as specific processors or memory requirements, instances to be allocated, etc., to be used when executing operations involved in tasks (e.g., training machine learning-based models, etc.). In examples where a provisioning request is received by the request management system 104 from the client device 102, the request management system 104 can process the provisioning request to determine whether to permit execution of the provisioning request, whether to implement updates to the provisioning request before execution is permitted, etc.

In some examples, the request management system 104 can implement (e.g., execute) a request processing system 108 to classify and/or otherwise process the provisioning request received from the client device 102. For example, the request management system 104 can execute the request processing system 108 to classify and/or process the provisioning request based on attributes, such as geographic location or domain, associated with resources 114 identified by the provisioning request. This classification can allow the request management system 104 to determine a set of resources 114 and/or configuration for the resources 114 maintained by the resource management system 112. For example, if a provisioning request involves initializing and training a new machine learning model, the request management system 104 can trigger a workflow that configures the resource management system 112 to select resources 114 within certain geographic regions and/or domains associated with the resource management system 112, train the machine learning model using designated datasets in accordance with the configuration established by the provisioning request, and generate a notification at the client device 102 upon completion of training.

In some embodiments, the request management system 104 can control the resource management system 112 by providing configuration instructions that align with respective provisioning requests. In an example, these instructions can configure the resource management system 112 to identify and allocate resources according to the specifications outlined in the provisioning requests. In some examples, this configuration process can involve causing the resource management system 112 to provision resources 114 with specific configurations, within specific geographic locations and/or domains, assign software licenses based on user roles, or establish network access with designated security settings.

In some embodiments, the request processing system 108 can obtain an indication of an amount of resources 114 involved in a provisioning request received by the request management system 104. For example, the request processing system 108 can analyze the provisioning request to determine the specific quantity of resources 114, such as CPUs/GPUs, memory capacity, bandwidth, duration, instances, etc., involved in the provisioning request. In some examples, the request processing system 108 can update the indication of the amount of the resources 114 by adjusting the indication, in accordance with a predetermined quantity to reflect a relative amount of resources 114 (which can be measured in accordance with predetermined instances that are associated with preconfigured specifications, such as GPUs, CPUs, memory, etc.) expected to be consumed by the provisioning request. In some examples, this adjustment performed by the request processing system 108 can standardize the metrics according to which the provisioning request is compared as described.

In some embodiments, the request management system 104 can be configured to determine a first request profile based on the provisioning request. For example, the request management system 104 can determine a first request profile based on a provisioning request received from the client device 102, where the first request profile indicates a first set of resources 114 (also referred to as network resources). The resources 114 can be associated with computing power, storage capacity, communication links, etc., maintained and allocated by the resource management system 112 when executing one or more operations associated with provisioning requests. In examples, the first request profile can further include a first location, which can represent a geographical area, a data center, a domain, a virtual environment, etc., where the resources 114 are to be provisioned.

In some embodiments, the request processing system 108 can determine a plurality of instant provisioning requests for the provisioning request generated by the client device 102, where each instant provisioning request specifies one or more resources 114 (e.g., an amount of network resources) to be provisioned at a specific point in time within a predetermined period of time. For example, the request processing system 108 can analyze the provisioning request to identify the resources 114 that satisfy one or more bandwidth, computing capacity, or storage aspects of the provisioning request, and allocate these resources dynamically across multiple time intervals within the predetermined period. Each instant provisioning request can correspond to a specific point in time and indicate the resources 114 that are involved with the provisioning request at that specific point in time. By segmenting the provisioning request into discrete, time-based instant provisioning requests, the request processing system 108 can determine whether the resource management system 112 can allocate resources 114 to satisfy the provisioning request, even in instances where certain portions of the provisioning request exceed the total resource availability at various points in time. While specific portions of the provisioning request may surpass available resources during particular moments within the predetermined period, aligning the instant provisioning requests with corresponding points in time, at which resources 114 are available, can allow the request processing system 108 to evaluate whether each instant provisioning request independently exceeds instant resource availability at a given point in time. This, in turn, can allow for a more granular assessment by the request processing system 108 when determining whether to permit or not permit execution of the provisioning request to allocate resources 114.

In some embodiments, the request processing system 108 can cause the resource management system 112 to provision the resources 114 to support a configuration of the resources 114 when processing network operations that involve dynamic allocation of resources 114 to scale with a given task. As one example, the request processing system 108 can cause the resource management system 112 to provision the resources 114 to support the implementation of a payment processing gateway by dynamically segmenting a provisioning request into discrete, instant provisioning requests when processing network operations (e.g., payment transactions, etc.). Each instant provisioning request can indicate an amount of resources 114 to be allocated at specific points in time within a predetermined period and can be determined based on prior provisioning requests involved in implementing the given task (e.g., processing the network operations, etc.). By analyzing historical network traffic data and determining rates at which resources were provisioned in accordance with prior, similar provisioning requests during prior periods of time, the request processing system 108 can derive a scaling profile that reflects expected resource consumption patterns that are associated with execution of the provisioning request. This scaling profile can be compared to a network resource profile to calculate execution probabilities as described herein, which represent the likelihood of successfully fulfilling or unsuccessfully fulfilling each instant provisioning request based on available resources. The request processing system 108 can further evaluate these execution probabilities against an execution threshold to ensure that resources 114 are available to support the successful completion of the provisioning request.

In some embodiments, the request management system 104 can be configured to compare the first request profile to a network resource profile to determine an execution probability. For example, the request processing system 108 can compare a first request profile to a network resource profile (e.g., maintained by the content database 116 as described) to evaluate the feasibility of executing a provisioning request. In an example, the request processing system 108 can obtain, for a period of time, a plurality of availability indicators corresponding to availability probabilities, where each availability indicator represents an available amount of resources 114 associated with provisioning requests for a predetermined configuration of resources 114. In this example, the request processing system 108 can analyze these availability indicators to assess the current and historical availability of the resources 114, such as bandwidth, server capacity, or storage space, across the specified time period. In some examples, the request processing system 108 can compare the first request profile to the plurality of availability indicators by matching the resources 114 identified by the provisioning request (as represented by the first request profile) and location specified in the first request profile against the available network resource data provided by the availability indicators. This comparison performed by the request processing system 108 can allow the request management system 104 to determine an execution probability, which represents the likelihood that the provisioning request can be successfully fulfilled based on the availability of the resources 114 and operational constraints associated with the resource management system 112.

In some embodiments, the request processing system 108 can determine that a provisioning request corresponds to a first period of time and, in response, identify a second period of time that occurs before the first period of time. For example, the request processing system 108 can offset a first point in time of the second period by a predetermined amount relative to a first point in time of the first period, establishing a temporal relationship between the two periods of time. The request processing system 108 can then compare the first request profile to a portion of the network resource profile (e.g., to availability indicators) corresponding to the second period of time. This comparison can involve evaluating the resource requirements specified in the first request profile against historical or projected availability data for resources 114 during the second period, as represented by the network resource profile. By analyzing this earlier timeframe, the request processing system 108 can determine patterns (e.g., trends) in availability of the resources 114 that can influence the feasibility of fulfilling the provisioning request during the first period.

In some embodiments, the request processing system 108 can determine that a provisioning request corresponds to a first period of time and can identify a second period of time that is at least in part after the first period of time. For example, the request processing system 108 can establish that a first point in time of the second period is offset by a predetermined amount relative to a first point in time of the first period (corresponding to the provisioning request). This temporal offset can allow the request processing system 108 to analyze (e.g., predict) resource availability extending beyond the initial timeframe associated with the provisioning request. In some examples, the request processing system 108 can then compare the first request profile to a portion of the network resource profile corresponding to the second period of time that is at least in part after the first period of time. This comparison can involve evaluating the resource requirements identified in the first request profile identifying the resources 114, against projected availability data for network resources during the second period of time. This projected availability data can be determined based on historical data associated with previously processed provisioning requests that correspond to similar periods of time. As one example, where a provisioning request involves the provisioning of resources 114 at a particular time during the day, a particular time during the week, a particular time during a month, or a particular time during the year, the request processing system 108 can obtain data representing whether or not similar provisioning requests were able to be successfully executed or were unsuccessful during those historical periods, and to what degree such provisioning and requests were likely to be executed successfully. By analyzing this subsequent timeframe, the request processing system 108 can assess whether sufficient resources are expected to remain available to support ongoing or future demands related to the provisioning request.

In some embodiments, the request processing system 108 can determine a location associated with a provisioning request, where the location indicates a physical location of at least one subsystem of the resource management system. For example, the request processing system 108 can analyze the provisioning request to extract location-specific details, such as geographical regions, data centers, or network zones, that are identified by the provisioning request. In this example, the location-specific details can correspond to resources 114 maintained by the resource management system 112. Based on this determined location, the request processing system 108 can select a network resource profile from among a plurality of network resource profiles, where each network resource profile corresponds to specific locations from among a plurality of locations. In some embodiments, in response to determining a network resource profile from among the plurality of network resource profiles based on the location associated with the provisioning request, the request processing system 108 can compare the first request profile to the network resource profile to determine an execution probability. This comparison can involve evaluating whether the set of resources 114 specified in the first request profile matches the availability and capacity outlined in the network resource profile for the given location. By performing this operation, the request processing system 108 can determine whether sufficient resources 114 are expected to be available at the specified location to fulfill the provisioning request.

In some embodiments, the request processing system 108 can determine that a provisioning request corresponds to a first network resource profile and, in response, the request processing system 108 can calculate a first execution probability by comparing a first request profile (or at least a portion thereof) to the first network resource profile (or at least a corresponding portion thereof). For example, the request processing system 108 can determine that the provisioning request corresponds to (e.g., indicates) a first network resource profile for resources 114 located at a first set of geographic areas (e.g., a first datacenter, a first group of datacenters, etc.). The request processing system 108 can then determine that the first execution probability satisfies an execution threshold. For example, the request processing system 108 can compare the first execution probability to an execution threshold and, in response, determine that the execution probability is at or below the execution threshold, indicating a lower than acceptable probability that the resources 114 will be allocated to satisfy the provisioning request. Th execution threshold can be a predetermined threshold, according to which the request processing system 108 determines whether or not to permit the execution of provisioning requests. The request processing system 108 can then identify a second network resource profile (e.g., at a different datacenter, group of datacenters, etc.) from among a plurality of network resource profiles based on the location associated with the provisioning request. The second network resource profile can correspond to additional or alternative resources 114 specific to the same location or a different location that can satisfy the provisioning request. In some embodiments, the request processing system 108 can compare the first request profile to the second network resource profile to calculate a second execution probability. The request processing system 108 can then compare the second execution probability to the execution threshold to determine whether the second execution probability threshold also satisfies the execution threshold. Where the request processing system 108 determines that the second execution probability is indicative of sufficient resources 114 being available, the request processing system 108 can determine that the resources 114 associated with the second network resource profile are to be used when executing the provisioning request.

In some embodiments, where the request processing system 108 determines a plurality of instant provisioning requests for a given provisioning request, the request processing system 108 can compare the plurality of instant provisioning requests to a network resource profile to determine a plurality of execution probabilities. For example, the request processing system 108 can analyze each instant provisioning request, which specifies resources 114 to be provisioned at specific points in time within a predetermined period of time associated with the provisioning request, against the network resource profile that indicates the probability that given resources 114 will be available over corresponding time intervals. In examples, the request processing system 108 can then calculate individual execution probabilities for each instant provisioning request, representing the likelihood that the resources 114 to satisfy the provisioning request will be available at each point in time. In some examples, the request processing system 108 can determine an overall execution probability based on the plurality of execution probabilities derived from the comparisons. This determination can involve aggregating or weighting the individual execution probabilities to produce a comprehensive probability for the provisioning request across all specified time intervals. In these examples, the request processing system 108 can account for temporal variations in availability of the resources 114 and confirm that operations involved in the provisioning request are optimized to align with both the immediate and long-term availability of resources 114. This can allow for efficient scheduling and allocation of resources 114 by the request management system 104 while maintaining adherence to operational constraints associated with the resource management system 112.

In some embodiments, the request management system 104 can be configured to compare an execution probability to an execution threshold. For example, where the request processing system 108 determines an execution probability or a plurality of execution probabilities corresponding to instant provisioning requests as described above, the request processing system 108 can compare one or more of the execution probabilities from the plurality of execution probabilities to an execution threshold to determine whether the one or more execution probabilities satisfy the execution threshold. For example, the request processing system 108 can evaluate individual execution probabilities, each representing the likelihood that a specific instant provisioning request can be fulfilled by the resource management system 112 based on the availability of resources 114 at particular points in time. By comparing these execution probabilities against the execution threshold, the request processing system 108 can determine whether the resources 114 are available to meet the requirements of the provisioning request during those specific time intervals. This can allow the request processing system 108 to identify which portions of the provisioning request are feasible under current or projected resource conditions. If one or more execution probabilities meet or exceed the execution threshold, the request processing system 108 can determine that the corresponding instant provisioning requests are expected to succeed with an acceptable degree of certainty. Conversely, if certain execution probabilities do not meet the execution threshold, the request processing system 108 can determine that potential resource constraints or mismatches may prevent unsuccessful fulfillment of those instant provisioning requests.

In some examples, the request updating system 110 can be executed by the request management system 104 and instances where the execution probability does not meet the execution threshold. For example, the request updating system 110 can determine that resource is 114 managed by the resource management system 112 in a particular geographic area, domain, etc. may be associated with an execution probability that does not satisfy the execution threshold. In this example, the request management system 104 can execute the request updating system 110 to identify one or more different resources 114, managed by the resource management system 112, and can cause the request processing system 108 to again evaluate the provisioning request in view of these one or more different resources 114. In examples where the request processing system 108 then determines that the one or more different resources are associated with an execution probability that does satisfy the execution threshold, the request updating system 110 can update the provisioning request to identify these one or more different resources 114. The request updating system 110 can then cause the provisioning request to be executed by the resource management system 112 similar to as described herein.

In some embodiments, the request management system 104 can be configured to control execution of the provisioning request based on the execution probability satisfying the execution threshold. For example, the request processing system 108 can cause the resource management system 112 to execute the provisioning request based on or more of the execution probabilities described in the examples above, satisfying the execution threshold. In response, the request processing system can cause the resource management system 112 to execute operations to allocate resources in accordance with the provisioning request.

In some embodiments, the request processing system 108 can determine one or more resource constraints associated with the resource management system 112 during the predetermined period of time and compare these resource constraints to the provisioning request to determine whether the provisioning request can be satisfied based on the availability of the resources 114. For example, the request processing system 108 can determine the resource constraints, where the resource constraints indicate the availability or non-availability of the resources 114. If the resources 114 available can satisfy the provisioning request, the request processing system 108 can cause the first system to execute the provisioning request. Additionally, or alternatively, if the resource is 114 available may not satisfy the provisioning request, the request processing system 108 can cause the resource management system 112 to execute an updated version of the provisioning request or to forego executing the provisioning request. As one example, causing the resource management system 112 to execute the provisioning request based on satisfying the resource constraints can involve updating the provisioning requests if the request processing system 108 determines that the provisioning request will fail at a specific point in time within the predetermined period. In this example, the request processing system 108 can identify a second network resource profile, comprising a second set of resources 114 and a second location, that can accommodate the provisioning request. The request processing system 108 can then cause the resource management system 112 to execute the provisioning request using the second set of network resources at the second location.

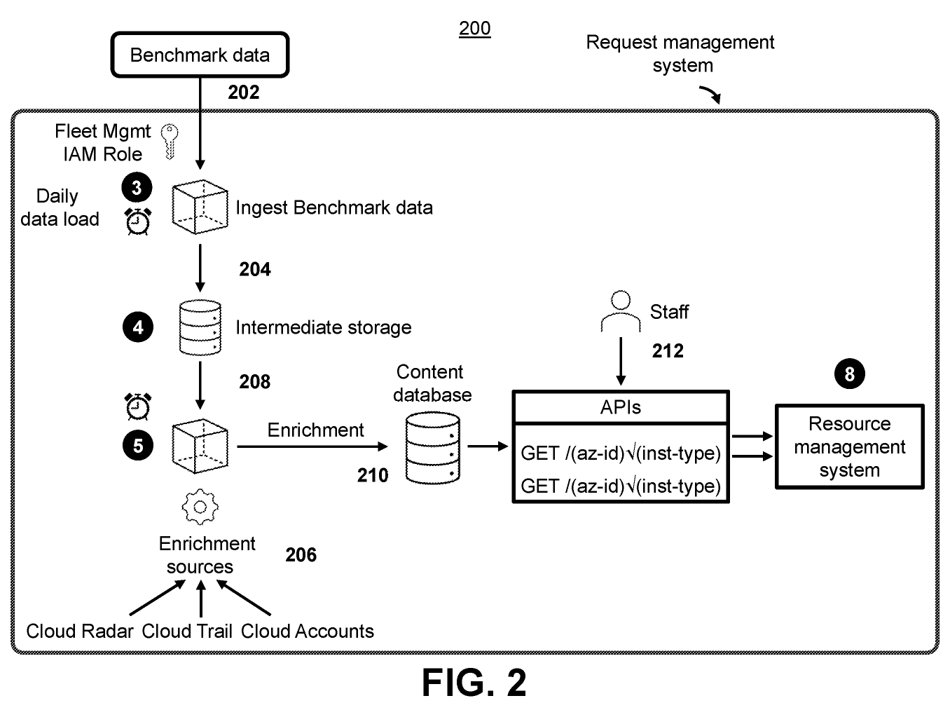

FIG. 2 shows a flow diagram of a process 200 for controlling execution of provisioning requests for cloud-based resources that are dynamically allocated, in accordance with one or more embodiments. In some embodiments, one or more operations described herein with respect to process 200 can be implemented by one or more devices that are the same as, or similar to, the those illustrated in the environment 100 of FIG. 1. For example, one or more of the operations described herein can be performed by a request management system that is the same as, or similar to, the request management system 104 of FIG. 1. In examples, one or more of the operations described herein can be performed by other components operating independent of or in coordination with the network component, such as a client device, a resource management system, and/or a content database that are the same as, or similar to, the client device 102, the resource management system 112, and/or the content database 116 of FIG. 1.

At 202, the request management system can obtain benchmark data associated with one or more probabilities that one or more resources (e.g., network resources such as specific processor configurations, memory allocations, or bandwidth capacities) will be available and allocated to a given provisioning request. For example, the request management system can obtain the benchmark data from a resource management system. The benchmark data can indicate probabilities that resources (e.g., that are the same as, or similar to, the resources 114 of FIG. 1) are available from the resource management system at one or more points in time during a period of time, and can be used to satisfy provisioning requests as described herein. These probabilities can correspond to points in time during the period of time and can indicate the likelihood that the resource management system will be configured to allocate resources in accordance with the provisioning request without pausing or canceling the execution of the provisioning request.

At 204, the request management system can process and store benchmark data for future use. For example, the resource management system can obtain the benchmark data from the resource management system and processes it to normalize various aspects represented by the data. The benchmark data can be normalized by comparing the measured performance metrics (e.g., processor type/speed, memory type/usage, or bandwidth utilization) against predefined thresholds to determine whether the required network resources (e.g., specific processor configurations, memory allocations, or bandwidth capacities) are available or insufficient Once normalized, the system stores the benchmark data in a content database, where the benchmark data can be updated or enriched with additional information.

At 206, the request management system can obtain data usable to enrich the benchmark data. For example, with respect to predetermined sets of resources (e.g., resource configurations within cloud regions, etc.), the request management system can integrate with cloud provider APIs to ensure the data aligns with the geographic regions where the request management system is provisioning resources to execute various tasks. In the case of IP address subnets, the request management system can analyze subnet configurations within specific domains and/or geographic regions to determine whether sufficient IP addresses are available to support the required number of instances in that region. Finally, historical trends can be derived by comparing capacity data provided by the resource management system with historical provisioning requests maintained by the request management system, allowing the request management system to confirm accuracy and predict the probability that future provisioning will be successfully executed. For example, trends representing an amount of resources provisioned by the request management system and/or an amount of resources made available by the resource management system can be plotted (e.g., as time-series graphs) to indicate the amount of resources provisioned and/or made available. In some examples, these trends can be plotted as separate curves and/or against one another to allow the resource management system to determine whether future provisioning requests (established based on trends represented by the plotted curves) are likely to be successfully executed or not executed.

At 208, the request management system can enrich the benchmark data to add details that associate resources with specific geographic regions and domains (e.g., cloud regions) where the transaction service provider is configuring the resource management system to perform one or more operations. This enrichment process can also include incorporating information about available IP address subnets in specific availability zones to determine whether the required number of instances can be supported. Additionally, the request management system can execute operations to analyze the resources managed by the resource management system and their locations within the resource management system.

In some embodiments, the request management system can further compare the resource management system’s capacity data with the provider’s historical provisioning data (represented in the benchmark data) to verify accuracy and predict future capacity needs. For example, the request management system can monitor the availability of resources (e.g., specific configurations of hardware such as sets of GPUs/CPUs/etc.) that were successfully provisioned at a previous point in time in a given availability zone. In this example, the request management system can compare the amount of resources successfully provisioned with an indication (e.g., provided by the resource management system) of the amount of resources that were available to be provisioned at the same point or period of time to determine a difference indicating an amount of resources that remained available during execution of the provisioning request. This can allow the request management system to obtain an indication from the resource management system of an amount of resources available at a particular point or period in time, and determine an amount of resources that remained available after one or more provisioning requests were executed by the request management system. This can allow the request management system to account for expected consumption of resources at future points or periods of time based on recurring provisioning requests generated by the request management system when determining whether one or more additional provisioning requests can be executed in addition to the expected requests (e.g., cyclical requests, etc. that are represented by the provisioning requests from the historical provisioning data).

At 210, the request management system can store the benchmark data in a content database for future use. For example, the resource management system can obtain the benchmark data based on the execution of operations to enrich and store the benchmark data in one or more datasets of the content database. The request management system can then analyze the benchmark data in response to one or more provisioning requests to determine whether or not to permit the provisioning requests to be provided to the resource management system.

In some embodiments, the request management system can generate a demand signal report based on the historical trends in compute resource production and consumption represented by the benchmark data. For example, the request management system can generate a demand signal report and send the demand signal report to the resource management system (e.g., via an API call) to the resource management system. This can allow the resource management system to more accurately determine updates to the resources (e.g., the hardware) managed by the resource management system and/or locations for the resources to satisfy future provisioning requests. In this example, the resource management system can calculate the strength of this demand signal by comparing actual resources identified by provisioning requests obtained by the resource management system and the number of provisioning requests that were not provisioned due to insufficient capacity against the resources managed by the resource management system.

Furthermore, the request management system can analyze these historical trends represented by the benchmark data to inform the resource management system about the resource management system hardware configuration updates. By specifying instance types and availability zones for migration, the request management system can allow the resource management system to provision new compute hardware to meet this demand. Repeated API calls can create a mutable demand inventory that the resource management system can use to plan capacity for the new hardware.

At 212, the request management system can obtain a provisioning request from a user operating a client device to obtain access to resources maintained by a resource management system when executing one or more tasks. In an example, the provisioning request can be received through a user application interface or triggered indirectly, based on input received at a client device, to configure the resource management system to execute tasks in accordance with a provisioning request. In this example, the request management system can analyze the provisioning request using historical data stored in a content database, where the historical data includes prior provisioning outcomes, approval patterns, and resource utilization metrics. In some examples, the analysis of the provisioning request can involve comparing the requested action against historical trends to identify potential conflicts, anomalies, or compliance issues. In another example, based on the analysis, the request management system can determine whether to permit execution of the provisioning request by evaluating factors, such as resource availability and approval requirements derived from historical data.

At 214, the request management system can approve the provisioning request or update and approve the provisioning request. In an example, once the provisioning request is approved or updated and approved, the request management system can transmit the provisioning request to a resource management system to control one or more resources managed by the resource management system. In this example, the resource management system can then execute the task in accordance with the provisioning request.

FIG. 3 shows illustrative components for a system used to controlling execution of provisioning requests for cloud-based resources that are dynamically allocated, in accordance with one or more embodiments. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 can alternatively be any computing device, as described above, and can include any type of mobile terminal, fixed terminal, or other device. For example, cloud components 310 can be implemented as a cloud computing system and can feature one or more component devices. It should also be noted that system 300 is not limited to three devices. Users can, for instance, utilize one or more devices to interact with one another, one or more servers, or other components of system 300. It should be noted that, while one or more operations are described herein as being performed by particular components of system 300, these operations can, in some embodiments, be performed by other components of system 300. As an example, while one or more operations are described herein as being performed by components of mobile device 322, these operations can, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 5, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces, nor displays, and can instead receive and display content using another device (e.g., a dedicated display device, such as a computer screen and/or a dedicated input device, such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storage. The electronic storages can include non-transitory storage media that electronically store information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a FireWire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice, or data network (e.g., a 5G or LTE network), a cable network, a public switched telephone network, or other types of communications networks or combinations of communications networks. Communication paths 328, 330, and 332 can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include model 302, which can be a machine learning model, an artificial intelligence model, etc. (which can be referred to collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train the model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network’s prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function, such that the signal must surpass it before it propagates to other neural units. Model 302 can be self-learning and trained, rather than explicitly programmed, and can perform significantly better in certain areas of problem-solving, as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, backpropagation techniques can be utilized by model 302, where forward stimulation is used to reset weights on the “front” neural units. In some embodiments, stimulation, and inhibition for model 302 can be more free-flowing, with connections interacting in a more chaotic and complex fashion. During testing, an output layer of model 302 can indicate whether or not a given input corresponds to a classification of model 302 (e.g., an action graph, a graph characteristic, a graph value, an objective, etc.).

In some embodiments, the model (e.g., model 302) can automatically perform actions based on outputs 306. In some embodiments, the model (e.g., model 302) cannot perform any actions. The output of the model (e.g., model 302) can be used to generate a response in a user interface.

System 300 also includes API layer 350. API layer 350 can allow the system to generate summaries across different devices. In some embodiments, API layer 350 can be implemented on mobile device 322 or user terminal 324. Alternatively, or additionally, the API layer 350 can reside on one or more of the cloud components 310. API layer 350 (which can be a REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 can use various architectural arrangements. For example, system 300 can be partially based on API layer 350, such that there is strong adoption of SOAP and RESTful Web services, using resources like Service Repository and Developer Portal, but with low governance, standardization, and separation of concerns. Alternatively, system 300 can be fully based on API layer 350, such that separation of concerns between layers like API layer 350, services, and applications is in place.

In some embodiments, the system architecture can use a microservice approach. Such systems can use two types of layers: Front-End Layer and Back-End Layer, where microservices reside. In this kind of architecture, the role of the API layer 350 can provide integration between the Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints by applying WAF and DDoS protection, and API layer 350 can use RESTful APIs as a standard for external integration.

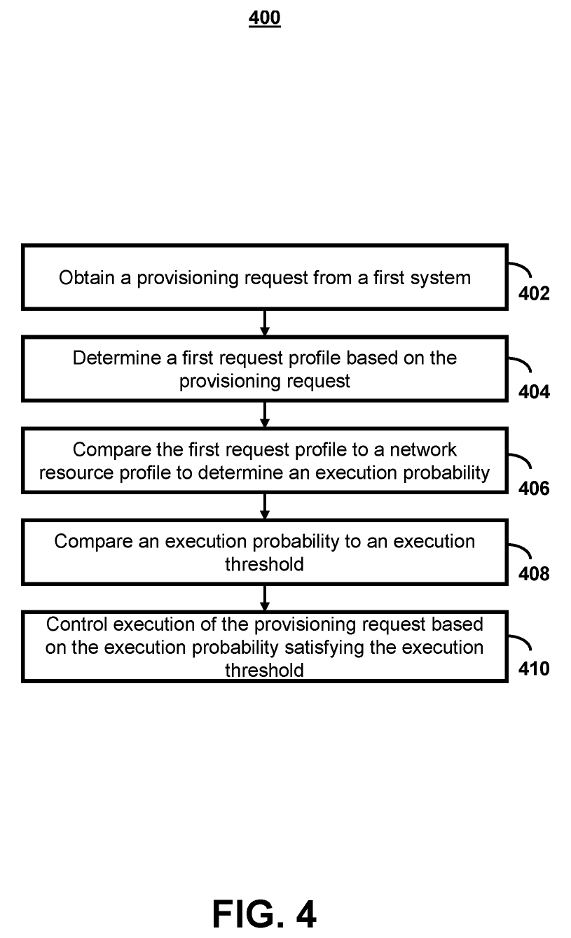

FIG. 4 shows a flowchart of the steps involved in a process 400 for controlling execution of provisioning requests for cloud-based resources that are dynamically allocated, in accordance with one or more embodiments. For example, a system that is the same as, or similar to, one or more of the systems and/or devices described with respect to FIG. 1, such as the request management system 104 (or one or more components thereof), can implement some or all of the operations described with respect to process 400.

At operation 402, the process 400 can include obtaining a provisioning request from a first system. For example, a request management system can obtain a request to provision resources associated with a resource management system. In examples, the resource management system can be associated with a cloud services provider or other similar distributed computing environment provider. In one example, the request management system can obtain a request for resources involved in executing one or more tasks, such as the training of machine learning models. In this example, the request management system can determine that the provisioning request indicates resources, such as CPUs, GPUs, memory, or disk space, involved in the training of the machine learning model.

At operation 404, the process 400 can include determining a first request profile based on the provisioning request. For example, a request management system can execute a request processing system to analyze the provisioning request. This can include identifying resources, such as CPUs, GPUs, instances, etc., that are involved in the execution of operations when performing a task. The request processing system can then generate the first request profile that can convert the identified resources to a standardized format.

At operation 406, process 400 can include comparing the first request profile to a network resource profile to determine an execution probability. For example, the request processing system can obtain data from content database, indicating one or more aspects of a network resource profile identified by the provisioning request to be used when processing the provisioning request. The request processing system can then compare one or more aspects of the first request profiles, such as the indication of one or more specific resources, to specific resources of the network resource profile. Based on this comparison, the request processing system can then determine an execution probability. This execution probability can be an indication of the likelihood that the resource management system will provision the resource is involved in the execution of the provisioning requests, without either pausing or deprovisioning he task during the execution of the provisioning request.

At operation 408, the process 400 can include comparing the execution probability to an execution threshold. For example, the request processing system can compare the execution probability determined based on the comparison of the first request profile to the network resource profile to determine whether the execution probability satisfies the execution threshold. In this example, the execution threshold can indicate a degree or probability, according to which the request processing system is configured to permit or not permit the execution of provisioning requests using resource management systems.

At operation 410, the process 400 can include controlling execution of the provisioning request based on the execution probability satisfying the execution threshold. For example, the request processing system can determine that the execution probably satisfies the execution threshold. In this example, this can include the execution probability being at or above a value established by the execution threshold. The request processing system can then provide the provisioning request to the resource management system to cause the resource management system to allocate resources in accordance with the provisioning requests. Once the resources are allocated and the task is completed the request management system can, in some examples, obtain data from the resource management system, indicating whether the provisioning request was successfully executed and whether or not the result of the provisioning request was provided to the client device, or another device as specified by the client device.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

An Application-Specific Integrated Circuit (ASIC) is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas, such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model’s computations, while ensuring efficient memory management and data movement. Because AI models, particularly deep learning networks, involve extensive matrix multiplications and tensor operations, specialized hardware units, such as systolic arrays or tensor processing units (TPUs), can be integrated to optimize these operations. To overcome this challenge, the system may use weight quantization, memory hierarchy optimization, and on-chip interconnects that can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC’s capabilities, reducing inefficiencies, and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims that follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for controlling execution of provisioning requests for cloud-based resources that are dynamically allocated.
2. The method of any one of the preceding embodiments, the method comprising: obtaining, a provisioning request from a first system for network resources at a second system, the provisioning request indicating a set of operations to execute using the second system; determining a first request profile based on the provisioning request, the first request profile comprising a first set of network resources and a first location; comparing the first request profile to a network resource profile of the second system to determine an execution probability, the execution probability indicating a probability that the set of operations will be executed by second system within a predetermined period of time; comparing the execution probability to an execution threshold to determine that the execution probability satisfies the execution threshold; and causing the first system to execute the provisioning request based on the execution probability satisfying the execution threshold.
3. The method of any one of the preceding embodiments, wherein obtaining the provisioning request comprises: obtaining an indication of an amount of the network resources involved in the provisioning request; and updating the indication of the amount of the network resources in accordance with a predetermined quantity to indicate a relative amount of network resources to be consumed by the provisioning request.
4. The method of any one of the preceding embodiments, wherein comparing the first request profile to the network resource profile comprises: obtaining, for a period of time, a plurality of availability indicators, each availability indicator of the plurality of availability indicators associated with an available amount of the network resources involved in provisioning requests for the predetermined quantity; and comparing the first request profile to the plurality of availability indicators to determine the execution probability.
5. The method of any one of the preceding embodiments, further comprising: determining a plurality of availability probabilities corresponding to the plurality of availability indicators; and updating the plurality of availability indicators based on the plurality of availability probabilities, wherein comparing the first request profile to the plurality of availability indicators comprises: comparing the first set of network resources to the plurality of availability probabilities.
6. The method of any one of the preceding embodiments, further comprising: determining that the provisioning request corresponds to a first period of time, and determining a second period of time that is before the first period of time, where a first point in time of the second period of time is offset by a predetermined amount from a first point in time of the first period of time, wherein comparing the first request profile to the network resource profile comprises: comparing the first request profile to a portion of the network resource profile corresponding to the second period of time prior to the first period of time.
7. The method of any one of the preceding embodiments, further comprising: determining that the provisioning request corresponds to a first period of time, and determining a second period of time that is at least in part after the first period of time, where a first point in time of the second period of time is offset by a predetermined amount from a first point in time of the first period of time, wherein comparing the first request profile to the network resource profile comprises: comparing the first request profile to a portion of the network resource profile corresponding to the second period of time that is at least in part after the first period of time.
8. The method of any one of the preceding embodiments, wherein comparing the first request profile to the network resource profile of the second system to determine the execution probability comprises: determining a location associated with the provisioning request, the location indicating a physical location of at least one subsystem of the second system; determining the network resource profile from among a plurality of network resource profiles based on the location associated with the provisioning request, each network resource profile corresponding to locations from among a plurality of locations; and in response to determining the network resource profile based on the location associated with the provisioning request, comparing the first request profile to the network resource profile to determine the execution probability.
9. The method of any one of the preceding embodiments, wherein the network resource profile comprises a first network resource profile, and the execution probability comprises a first execution probability, the method further comprising: in response to determining that the first execution probability satisfies the execution threshold, determining a second network resource profile from among the plurality of network resource profiles based on the location associated with the provisioning request; comparing the first request profile to the second network resource profile to determine a second execution probability; and comparing the second execution probability to the execution threshold to determine that the second execution probability satisfies the execution threshold, wherein causing the first system to execute the provisioning request based on the first execution probability satisfying the execution threshold comprises: causing the first system to execute the provisioning request in accordance with a location corresponding to the second network resource profile.
10. The method of any one of the preceding embodiments, wherein determining the first request profile comprises: determining a plurality of instant provisioning requests based on the provisioning request, each instant provisioning request indicating an amount of the network resources to be provisioned at a point in time within the predetermined period of time, wherein comparing the first request profile to the network resource profile comprises: comparing the plurality of instant provisioning requests to the network resource profile to determine a plurality of execution probabilities, and determining the execution probability based on the plurality of execution probabilities.
11. The method of any one of the preceding embodiments, wherein the execution probability comprises a plurality of execution probabilities, wherein determining the first request profile comprises: determining a plurality of instant provisioning requests based on the provisioning request, each instant provisioning request indicating an amount of the network resources to be provisioned at a point in time within the predetermined period of time, and wherein comparing the first request profile to the network resource profile comprises: comparing the plurality of instant provisioning requests to network resources of the second system available at a plurality of points in time to determine a plurality of execution probabilities, wherein comparing the execution probability to the execution threshold comprises: comparing one or more execution probabilities of the plurality of execution probabilities to the execution threshold to determine that the one or more execution probabilities satisfies the execution threshold.
12. The method of any one of the preceding embodiments, wherein determining the first request profile comprises: determining, based on the first request profile, a scaling profile indicating a first rate at which the set of operations are configured to consume network resources, wherein comparing the first request profile to the network resource profile comprises: comparing the scaling profile to the network resource profile to determine the execution probability.
13. The method of any one of the preceding embodiments, wherein determining the scaling profile comprises: obtaining network traffic data associated with network traffic at a plurality of points in time over one or more periods of time before the predetermined period of time; determining one or more rates according to which network resources are provisioned based on the network traffic at the plurality of points in time; and determining the scaling profile based on the one or more rates according to which the network resources are provisioned.
14. The method of any one of the preceding embodiments, further comprising: determining one or more resource constraints associated with the first system during the predetermined period of time; and comparing the one or more resource constraints to the provisioning request to determine the provisioning request satisfies the one or more resource constraints, wherein causing the first system to execute the provisioning request comprises: causing the first system to execute the provisioning request based on the provisioning request satisfying the one or more resource constraints.
15. The method of any one of the preceding embodiments, wherein causing the first system to execute the provisioning request based on the provisioning request satisfying the one or more resource constraints comprises: determining that the provisioning request will fail at a point in time associated with the predetermined period of time; determining a second network resource profile comprising a second set of network resources and a second location; and causing the first system to execute the provisioning request in accordance with the second set of network resources at the second location.
16. One or more non-transitory, computer-readable mediums storing instructions recorded thereon that, when executed by a data processing apparatus, cause the data processing apparatus to perform operations comprising those of any of embodiments 1–15.
17. A system comprising one or more processors and memory storing instructions that, when executed by the processors, cause the processors to effectuate operations comprising those of any of embodiments 1–15.
18. A system comprising means for performing any of embodiments 1–15.

What is claimed is:

1. A system for controlling execution of provisioning requests for cloud-based resources that are dynamically allocated, the system comprising:
one or more processors configured to:
obtain a provisioning request from a first system for network resources at a second system, the provisioning request indicating a set of operations to execute using the second system;
determine a first request profile based on the provisioning request, the first request profile comprising a first set of network resources and a first location that are to be consumed when completing execution of network operations associated with the set of operations;
compare the first request profile to a network resource profile of the second system to determine an execution probability, the execution probability indicating a probability that the set of operations will be successfully executed by second system within a predetermined period of time;
compare the execution probability to an execution threshold to determine whether the execution probability indicates that the second system is configured to successfully execute the provisioning request; and
control the first system to execute the provisioning request based on the execution probability satisfying the execution threshold to reduce the probability that the execution will be unsuccessful.

2. A method, comprising:
obtaining, a provisioning request from a first system for network resources at a second system, the provisioning request indicating a set of operations to execute using the second system;
determining a first request profile based on the provisioning request, the first request profile comprising a first set of network resources and a first location;
comparing the first request profile to a network resource profile of the second system to determine an execution probability, the execution probability indicating a probability that the set of operations will be executed by second system within a predetermined period of time;
comparing the execution probability to an execution threshold to determine that the execution probability satisfies the execution threshold; and
causing the first system to execute the provisioning request based on the execution probability satisfying the execution threshold.

3. The method of claim 2, wherein obtaining the provisioning request comprises:
obtaining an indication of an amount of the network resources involved in the provisioning request; and
updating the indication of the amount of the network resources in accordance with a predetermined quantity to indicate a relative amount of network resources to be consumed by the provisioning request.

4. The method of claim 3, wherein comparing the first request profile to the network resource profile comprises:
obtaining, for a period of time, a plurality of availability indicators, each availability indicator of the plurality of availability indicators associated with an available amount of the network resources involved in provisioning requests for the predetermined quantity; and
comparing the first request profile to the plurality of availability indicators to determine the execution probability.

5. The method of claim 4, further comprising:
determining a plurality of availability probabilities corresponding to the plurality of availability indicators; and
updating the plurality of availability indicators based on the plurality of availability probabilities,
wherein comparing the first request profile to the plurality of availability indicators comprises:
comparing the first set of network resources to the plurality of availability probabilities.

6. The method of claim 2, further comprising:
determining that the provisioning request corresponds to a first period of time, and
determining a second period of time that is before the first period of time, where a first point in time of the second period of time is offset by a predetermined amount from a first point in time of the first period of time,
wherein comparing the first request profile to the network resource profile comprises:
comparing the first request profile to a portion of the network resource profile corresponding to the second period of time prior to the first period of time.

7. The method of claim 6, further comprising:
determining that the provisioning request corresponds to a first period of time, and
determining a second period of time that is at least in part after the first period of time, where a first point in time of the second period of time is offset by a predetermined amount from a first point in time of the first period of time,
wherein comparing the first request profile to the network resource profile comprises:
comparing the first request profile to a portion of the network resource profile corresponding to the second period of time that is at least in part after the first period of time.

8. The method of claim 2, wherein comparing the first request profile to the network resource profile of the second system to determine the execution probability comprises:
determining a location associated with the provisioning request, the location indicating a physical location of at least one subsystem of the second system;
determining the network resource profile from among a plurality of network resource profiles based on the location associated with the provisioning request, each network resource profile corresponding to locations from among a plurality of locations; and
in response to determining the network resource profile based on the location associated with the provisioning request, comparing the first request profile to the network resource profile to determine the execution probability.

9. The method of claim 8, wherein the network resource profile comprises a first network resource profile, and the execution probability comprises a first execution probability, the method further comprising:
in response to determining that the first execution probability satisfies the execution threshold, determining a second network resource profile from among the plurality of network resource profiles based on the location associated with the provisioning request;
comparing the first request profile to the second network resource profile to determine a second execution probability; and
comparing the second execution probability to the execution threshold to determine that the second execution probability satisfies the execution threshold,
wherein causing the first system to execute the provisioning request based on the first execution probability satisfying the execution threshold comprises:
causing the first system to execute the provisioning request in accordance with a location corresponding to the second network resource profile.

10. The method of claim 2, wherein determining the first request profile comprises:
determining a plurality of instant provisioning requests based on the provisioning request, each instant provisioning request indicating an amount of the network resources to be provisioned at a point in time within the predetermined period of time,
wherein comparing the first request profile to the network resource profile comprises:
comparing the plurality of instant provisioning requests to the network resource profile to determine a plurality of execution probabilities, and
determining the execution probability based on the plurality of execution probabilities.

11. The method of claim 2, wherein the execution probability comprises a plurality of execution probabilities,
wherein determining the first request profile comprises:
determining a plurality of instant provisioning requests based on the provisioning request, each instant provisioning request indicating an amount of the network resources to be provisioned at a point in time within the predetermined period of time, and
wherein comparing the first request profile to the network resource profile comprises:
comparing the plurality of instant provisioning requests to network resources of the second system available at a plurality of points in time to determine a plurality of execution probabilities,
wherein comparing the execution probability to the execution threshold comprises:
comparing one or more execution probabilities of the plurality of execution probabilities to the execution threshold to determine that the one or more execution probabilities satisfies the execution threshold.

12. The method of claim 2, wherein determining the first request profile comprises:
determining, based on the first request profile, a scaling profile indicating a first rate at which the set of operations are configured to consume network resources,
wherein comparing the first request profile to the network resource profile comprises:
comparing the scaling profile to the network resource profile to determine the execution probability.

13. The method of claim 12, wherein determining the scaling profile comprises:
obtaining network traffic data associated with network traffic at a plurality of points in time over one or more periods of time before the predetermined period of time;
determining one or more rates according to which network resources are provisioned based on the network traffic at the plurality of points in time; and
determining the scaling profile based on the one or more rates according to which the network resources are provisioned.

14. The method of claim 2, further comprising:
determining one or more resource constraints associated with the first system during the predetermined period of time; and
comparing the one or more resource constraints to the provisioning request to determine the provisioning request satisfies the one or more resource constraints,
wherein causing the first system to execute the provisioning request comprises:
causing the first system to execute the provisioning request based on the provisioning request satisfying the one or more resource constraints.

15. The method of claim 14, wherein causing the first system to execute the provisioning request based on the provisioning request satisfying the one or more resource constraints comprises:
determining that the provisioning request will fail at a point in time associated with the predetermined period of time;
determining a second network resource profile comprising a second set of network resources and a second location; and
causing the first system to execute the provisioning request in accordance with the second set of network resources at the second location.

16. One or more non-transitory, computer-readable mediums comprising instructions that, when executed by one or more processors, cause the one or more processors to perform operations comprising:
obtaining, a provisioning request from a first system for network resources at a second system, the provisioning request indicating a set of operations to execute using the second system;
determining a first request profile based on the provisioning request, the first request profile comprising a first set of network resources and a first location;
comparing the first request profile to a network resource profile of the second system to determine an execution probability, the execution probability indicating a probability that the set of operations will be executed by second system within a predetermined period of time;
comparing the execution probability to an execution threshold to determine that the execution probability satisfies the execution threshold; and
causing the first system to execute the provisioning request based on the execution probability satisfying the execution threshold.

17. The one or more non-transitory, computer-readable mediums of claim 16, wherein the instructions that cause the one or more processors to obtain the provisioning request cause the one or more processors to:
obtaining an indication of an amount of the network resources involved in the provisioning request; and
updating the indication of the amount of the network resources in accordance with a predetermined quantity to indicate a relative amount of network resources to be consumed by the provisioning request.

18. The one or more non-transitory, computer-readable mediums of claim 17, wherein the instructions that cause the one or more processors to compare the first request profile to the network resource profile cause the one or more processors to:
obtaining, for a period of time, a plurality of availability indicators, each availability indicator of the plurality of availability indicators associated with an available amount of the network resources involved in provisioning requests for the predetermined quantity; and
comparing the first request profile to the plurality of availability indicators to determine the execution probability.

19. The one or more non-transitory, computer-readable mediums of claim 18, wherein the instructions further cause the one or more processors to:
determining a plurality of availability probabilities corresponding to the plurality of availability indicators; and
updating the plurality of availability indicators based on the plurality of availability probabilities,
wherein comparing the first request profile to the plurality of availability indicators comprises:
comparing the first set of network resources to the plurality of availability probabilities.

20. The one or more non-transitory, computer-readable mediums of claim 16, where in the instructions further cause the one or more processors to:
determining that the provisioning request corresponds to a first period of time, and
determining a second period of time that is before the first period of time, where a first point in time of the second period of time is offset by a predetermined amount from a first point in time of the first period of time,
wherein comparing the first request profile to the network resource profile comprises:
comparing the first request profile to a portion of the network resource profile corresponding to the second period of time prior to the first period of time.
